(19) United States
(12) Patent Application Publication
(10) Pub. No.: US 2025/0241806 A1
(43) Pub. Date: Jul. 31, 2025

(54) ACCESS SYSTEM FOR A TRANSPORT VEHICLE

(71) Applicant: Robbie Phelan, Dooreen (AU)

(72) Inventor: Robbie Phelan, Dooreen (AU)

(21) Appl. No.: 18/847,699

(22) PCT Filed: Mar. 20, 2023
(86) PCT No.: PCT/AU2023/050198

§ 371 Date: Sep. 17, 2024

(30) Foreign Application Priority Data
Mar. 18, 2022 (AU) 2022900674

(51) Int. Cl. A61G 3/06; B61B 1/02

(52) U.S. Cl. CPC A61G 3/061; B61B 1/02

(57) ABSTRACT

An access system for providing ramp access to a vehicle comprising: a containment module mounted within a ground surface; a subframe member mounted to a base surface of the containment module to extend substantially over the base surface of the containment module; a tilting frame pivotally mounted to the subframe member and actuable such that a free end of the tilting frame is able to be elevated and lowered with respect to the subframe member; a extension frame mounted within the tilting frame adjacent the free end thereof, the extension frame actuable to extend from and retract into the extension frame when the extension frame is in an elevated position; wherein, movement of the tilting frame and the extension frame is controlled by a controller to extend from the ground surface to the vehicle to facilitate ramp access to the vehicle

### RELATED APPLICATION(S)

The present application claims priority from Australian Provisional patent Application No. 2022900674 filed 19 Mar. 2022, the entire contents of which are incorporated herein by reference.

### FIELD OF INVENTION

The present invention relates generally to an access system for accessing a transport vehicle, and in particular, to an access platform for accessing a public transport vehicle at a dedicated station.

### BACKGROUND OF THE INVENTION

Public transport vehicles, such as light rail, buses, and the like, typically make use of existing roadways to navigate a town or city. Typically, the roadways have dedicated “stops”, which define points along the roadways where the vehicle will stop to collect passengers and to allow passengers to exit the vehicle. Such stops may be signposted and have appropriate barriers installed to alert passengers and other road users, such as drivers of cars or trucks, that passengers will be crossing the roadway to access the public transport vehicle.

Given the nature of light rail vehicles, buses and the like, there is typically a need for passengers to step up onto the vehicle to enter the vehicle, and to step down from the vehicle to exit the vehicle. This is typically not such an issue in train stations as the stations typically comprise an elevated platform that is elevated above a rail line. In this regard, when the train arrives at the platform, an individual can simply step into the carriage, through the carriage door, without generally having to perform a climbing motion. The edge of the platform is positioned as close as possible to minimise any gap between the platform and the train when the train is positioned at the platform, which may prove an obstacle to the passenger boarding the carriage.

For buses and light rail vehicles, the road surface is generally below the access door, requiring passengers to step up/down to enter/leave the vehicle. As a result, bus and light train use has proven difficult for passengers who may be using a wheelchair or similar mobility assistive device, or a pram. Typically, such wheeled devices are unable to negotiate the step between the roadway and the vehicle door and such individuals either do not use such public transport or are often reliant upon the manual placement of a ramp or similar bridging device between the roadway and the vehicle door to access the vehicle. Often, such ramps are not available at most stops.

Thus, there is a need to provide an access system for accessing a transport vehicle on a public roadway that can be used by those requiring ramp access to the vehicle and which is a simple and automated means for accessing the vehicle.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided an access system for providing ramp access to a vehicle comprising:
a containment module mounted within a ground surface;
a subframe member mounted to a base surface of the containment module to extend substantially over the base surface of the containment module;
a tilting frame pivotally mounted to the subframe member and actuable such that a free end of the tilting frame is able to be elevated and lowered with respect to the subframe member;
a extension frame mounted within the tilting frame adjacent the free end thereof, the extension frame actuable to extend from and retract into the extension frame when the extension frame is in an elevated position;
wherein, movement of the tilting frame and the extension frame is controlled by a controller to extend from the ground surface to the vehicle to facilitate ramp access to the vehicle.

In one embodiment, the containment module may be in the form of a pre-cast concrete member defining an open rectangular structure having an interior space bounded by walls extending in an upright manner from a base surface.

The containment module configured to be embedded into a road. The base surface of the containment module may be configured to have a one or more drainage channels formed in the surface thereof. The drainage channels may function to direct any water collected within the containment module towards a rear channel formed along a rear wall of the containment module. The water collected in the rear channel may be removed via drain pipes into the surrounding soil.

The subframe member may be positioned within the containment module to be secured to the base thereof.

The subframe member may have an end that extends vertically, the vertically extending end configured to be extend across a rear end of the containment module.

An opposing end of the subframe member may be configured to be located along a front end of the containment module. The opposing end may have impact buffers formed along an upper surface thereof. The impact buffers may be in the form of rubber pads.

Lifting mechanisms may be mounted to opposing sides the subframe member at a central region thereof and may be in engagement with the tilting frame.

The lifting mechanisms may comprise a cam lifter in communication with at least one motor. The height of extension of the tilting frame is controlled by controlling rotational orientation of the cam member mounted beneath the tilting frame.

The extension frame may be mounted within the tilting frame adjacent a front end thereof. The extension frame may be mounted on runners so as to slide within the extension frame.

A linear actuator may be mounted at one end to the tilting frame and may be connected to a rear of the extension frame. The linear actuator may be actuable to apply a pushing force against the rear of the extension frame to extend the front end of the extension frame beyond the end of the tilting frame and to apply a pulling force against the rear of the extension frame to retract the front end of the extension frame into the end of the tilting frame.

A platform member may be mounted to an upper surface of the extension frame. The platform member may move with the extension frame and may have a bumper provided along the free end thereof such that as the platform member extends beyond the tilting frame the bumper contacts the vehicle.

A decking member may be mounted to an upper surface of the tilting frame to extend substantially over the ramp system.

### BRIEF DESCRIPTION OF THE DRAWINGS

The invention may be better understood from the following non-limiting description of preferred embodiments, in which:

FIG. 1 is a perspective view of an access system in accordance with an embodiment of the present invention for facilitating access to a tram or light rail vehicle;

FIG. 2 is a perspective view of the access system of FIG. 1 in use;

FIG. 3 is an exploded view depicting the ramp system in accordance with an embodiment of the present invention;

FIG. 4 is a front side perspective view of the ramp system of FIG. 3; and

FIG. 5 is a rear side perspective view of the ramp system of FIG. 3.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to the accessibility of a wheel-chair passenger to a carriage of a tram or similar vehicle that uses a conventional roadway without a dedicated elevated platform. However, it will be appreciated that the system of the present invention could be used by a variety of different passengers requiring access to a bus, tram or similar vehicle, including passengers in mobility scooters and passengers with prams or other wheeled contrivances.

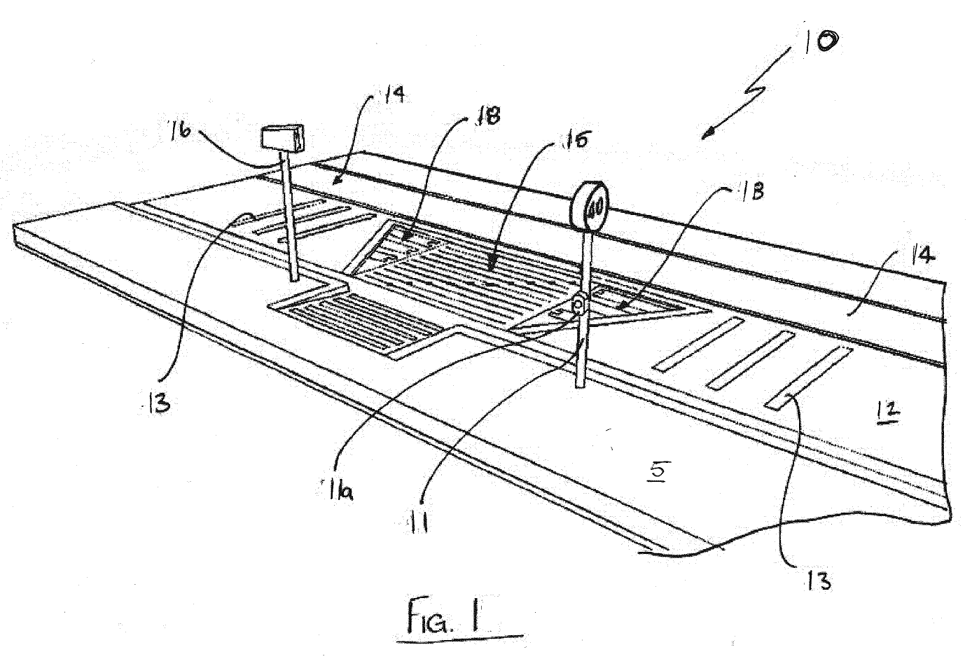

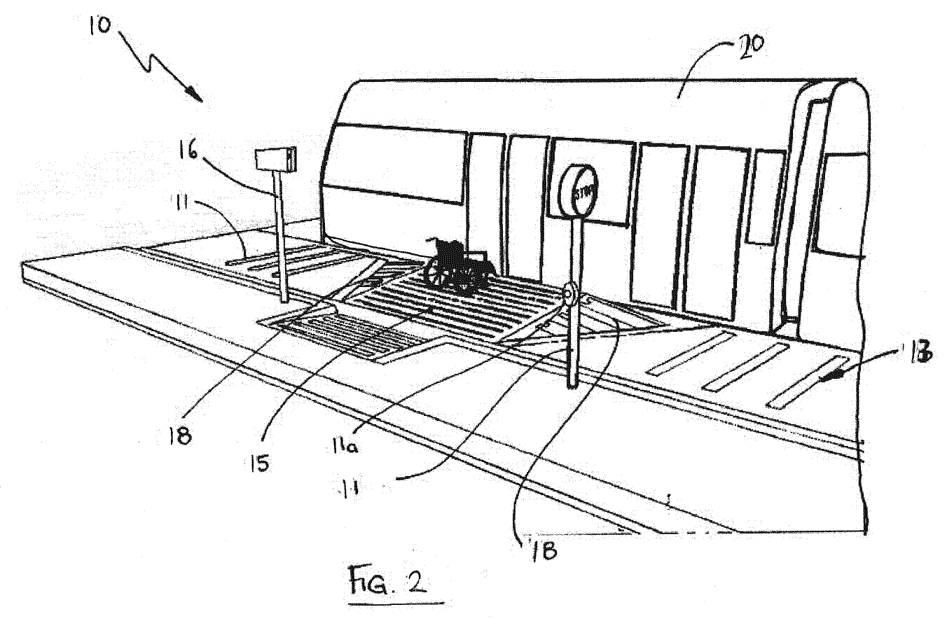

As is shown in FIGS. 1 and 2, the access system 10 of the present invention is shown installed for use in relation to light rail or tram vehicle. In such applications tram stops are integrated into a conventional roadway arrangement as shown in FIG. 1.

The tram stop is located adjacent a road 12 that accommodates general traffic in a conventional manner. Tracks 14 are provided within the surface of the road 12 along which the tram 20 will travel. Such tracks 14 are generally provided in a centre of the road such that vehicle traffic can still proceed along opposing sides of the tracks 14. In this regard, in order to passengers to alight the tram 20 at the stop, the passengers await the arrival of the tram 20 whilst on the roadside or sidewalk 5, such that when the tram 20 arrives at the stop, the passengers must traverse the road 12 to access the tram 20.

The access system 10 comprises a ramp system 15, which, when not in use, is located flush with the surface of the road 12. The surface of the road 12 is configured with signage 13 to designate a zone in which traffic is not to enter when the tram is at the stop, as is consistent with most road safety rules.

Additional warning signage 11 may also be provided on the side of the road 12 to provide further safety information which may be highlighted through the use of LEDs and the like.

In one embodiment, the signage 11 may include a button 11a that can be depressed by a waiting passenger, such as a wheelchair passenger, who requires use of the ramp to access the tram. Upon depressing the button 11a, a signal will be transmitted to the tram 20 to confirm that there is a passenger awaiting the tram at the next stop and that the passenger will be requiring use of the ramp 15 upon arrival of the tram at the tram stop. The system will then receive a return signal from the tram 20 acknowledging receipt of the signal, which may also include an ID signal to determine the type of tram approaching the tram stop to ensure that the ramp system 15 will be activated to the desired height to provide smooth transit of the passenger onto the tram. In this embodiment, a controller may be mounted in the button 11a to transmit and receive such signals. A camera 16 may also be provided to monitor the access system 10 in use and can be configured to identify a wheelchair passenger awaiting the tram 20 and automatically transmit signals to and from the tram 20 to facilitate activation of the ramp system 15 in the desired manner when the tram arrives at the stop.

In an alternative embodiment, the ramp system 15 will automatically activate when a tram arrives at the stop via detection sensors that detect the tram 20 and activate the ramp system 15 accordingly.

As is depicted more clearly in FIG. 2, the ramp system 15 has side members 18 hingedly connected to the ramp system 15 and the road 12 along sides of the ramp system 15. The side members 18 are in the form of triangular shaped members that function to maintain coverage of the gap between the ramp system 15 and the surface of the road 12 as the ramp system is raised and lowered. The side members 18 are substantially planar members and are made from a durable material such that when they are in the lowered position, as shown in FIG. 10, the side members 18 can support traffic travelling thereon. When the ramp system 15 is in the raised or activated position of FIG. 2, the side members provide a smooth transition between the sides of the ramp system 15 and the surface of the road 12 to support a passenger travelling over the side members 18 to access the tram 20.

The flexible hinged connection between the side members 18 and the ramp system 15 and road 12 ensures that, irrespective of the height in which the ramp system 15 is to be elevated to, there is no gap present between the corresponding surfaces which may form a tripping hazard to passengers.

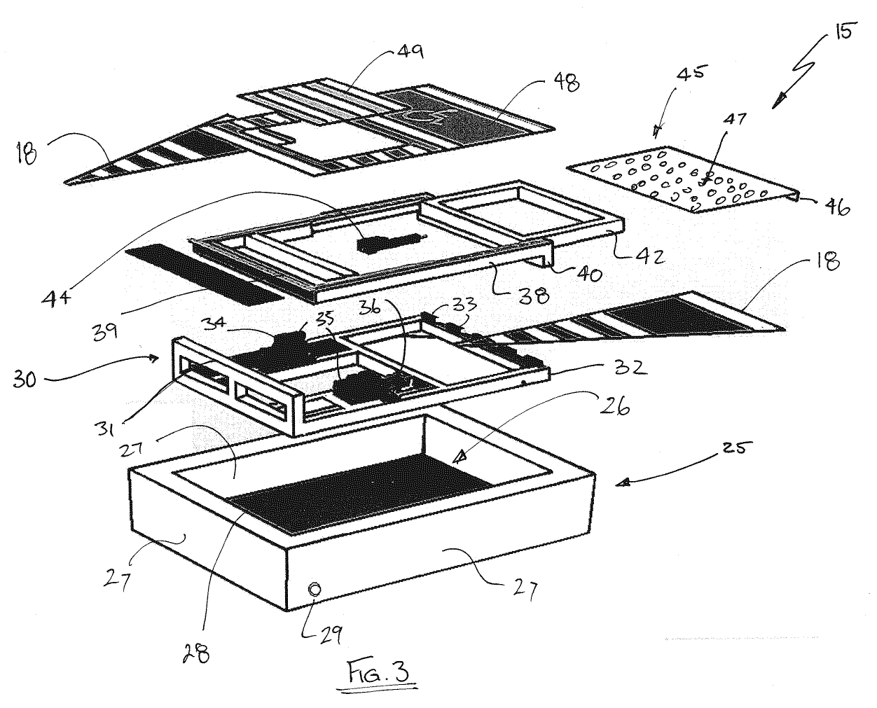

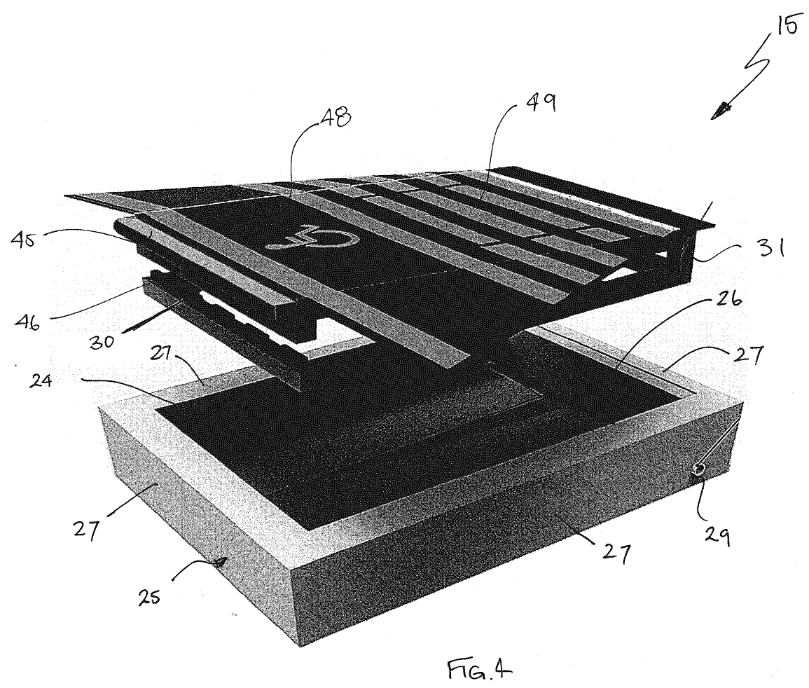

Referring to FIGS. 3-5, the ramp system 15 is shown in detail.

The ramp system 15 generally comprises a containment module 25 in the form of a pre-cast concrete member defining an open rectangular structure having an interior space 26 bounded by walls 27 extending in an upright manner from a base 28. The containment module 25 is fully reinforced and is configured to be embedded into the road 12 to contain the components of the ramp system 15. In this regard, the base 28 is configured to have a one or more drainage channels 24 formed in a surface thereof. The draining channels function to direct any water collected within the containment module 25 towards a rear channel formed along a rear wall of the module 25 such that any collected water can be drained away via drain pipes 29 into the surrounding soil. This ensures that rainwater does not collect within the module 25 during use.

A subframe 30 is positioned within the containment module 25 to be secured to the base 28 thereof. The subframe 30 is formed from steel tubing and forms a framework for supporting the features of the ramp system 15. The subframe 30 has an end 31 that extends vertically, with the end 31 configured to be located across a rear end of the containment module 25. The opposing end 32 of the subframe 30 is configured to be located along a front end of the containment module 25. The opposing end 32 has impact buffers 33 formed along an upper surface thereof, in the form of rubber pads or the like.

Centrally mounted along opposing sides the subframe 30 are the lifting mechanisms 34. Each of the lifting mechanisms 34 comprise an electric motor 35 in communication with a cam lifter 36 to provide the lifting motion of the ramp system 15, as will be discussed in more detail below. In the embodiment as shown, each cam lifter 36 is in communication with a electric motor 35; however, it will be appreciated that the cam lifters 36 may be controlled by a single electric motor to provide for synchronicity of movement of the cam lifters 36.

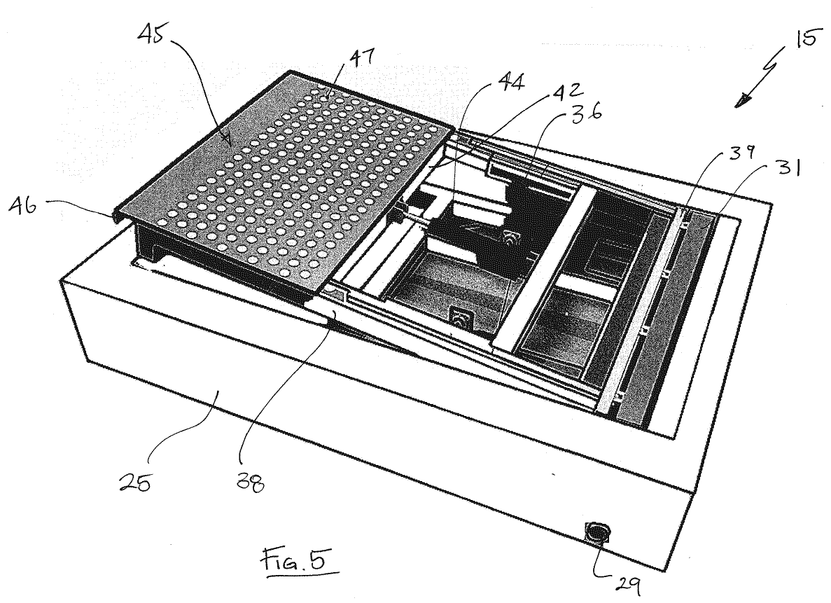

A tilting frame 38 is mounted to the subframe 30 such that it is pivotally connected to the subframe 30 at the rear end 31 thereof by way of a pivot plate 39. The tilting frame 38 extends along the upper surface of the subframe 30 and has a lip 40 extending along an underside of the front end thereof. The lip 40 is supported on the impact buffers 33 provided on the front end 32 of the subframe 30 such that the tilting frame 38 extends substantially parallel with the subframe 30 when in an unraised position. In this position, the cam lifters 36 of the lifting mechanism 34 are each located under the opposing sides of the tilting frame 38 such that upon activation of the motors 35, the cam lifters 36 will rotate and cause the tilting frame 38 to pivot in an upward manner, thereby raising the free end of the tilting frame 38, as shown in FIG. 5.

An extension frame 42 is mounted within the tilting frame 38 adjacent a front end thereof. The extension frame 42 is contained within the tilting frame 38 and is mounted on runners 43 so as to slide within the extension frame 42. A linear actuator 44 is mounted at one end to the tilting frame 38 and is connected to a rear of the extension frame 42. The linear actuator 44 is actuated to apply a pushing force against the rear of the extension frame 42 to push the front end of the extension frame 42 beyond the end of the tilting frame 38.

A platform member 45 is mounted to an upper surface of the extension frame 42 as shown in FIG. 5. The platform member 45 moves with the extension frame 42 and has a bumper 46 provided along the free end thereof such that as the platform member 45 extends beyond the tilting frame 38 the bumper 46 is able to contact the tram 20 adjacent the base of the door to ensure that the platform member 45 extends to the tram with minimal gap formed therebetween. The bumper 46 may be made from a rubber material.

The platform member 45 may have a plurality of pad members 47 formed on the upper surface thereof to ensure that there is sufficient friction on the surface of the platform member 45 to minimise slippage as the passengers travel thereon. It will be appreciated that other materials could also be used for this purpose.

To complete the ramp system 15, a decking member 48 is mounted to the upper surface of the tilting frame 38 to provide a surface over the ramp system 15. The decking member 48 has sufficient structural integrity to accommodate the weight of a vehicle passing over the ramp system 15 when embedded in the road 12 as shown in FIGS. 1 and 2. An access hatch 49 may be provided in the decking member 28 to access the internal components of the ramp system for maintenance and the like.

It will be appreciated that when the ramp system is installed in the road 12, in the manner as shown in FIGS. 1 and 2, the ramp system 15 may be controlled by a controller unit mounted in the module 25 or in a roadside compartment. The controller may include a microcontroller capable of activating the lifting mechanism 34 to tilt the tilting frame 38 a desired height to accommodate the tram 20. The microcontroller will also control the linear actuator 44 to extend the extension frame 42 and associated platform 45 towards the tram such that the bumper 46 is in contact with the wall of the tram 20. This will enable passengers to access the tram as well as to alight from the tram as required, in a safe and controlled manner. Prior to the tram departing the stop, the microcontroller will cause the linear actuator to retract the platform 45 and cause the lifting mechanism 34 to lower the tilting frame, thereby returning the components within the module 25 such that the decking member 48 and the pivotably connected side members 18 sit flush with the road surface to accommodate traffic passing thereon.

It will be appreciated that in such an access system 10, wheel chair passengers located at a roadside tram stop can confidently await a tram knowing that when the tram arrives there will be smooth access via the ramp system 15 to the tram. Similarly, road users will be able to use the road in a conventional manner and the tram driver will not be required to leave the tram to install a ramp, ensuring a more efficient process with minimal delays.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the system uppermost.

It will be appreciated by those skilled in the art that many modifications and variations may be made to the methods of the invention described herein without departing from the spirit and scope of the invention.

1. An access system for providing ramp access to a vehicle comprising:
a containment module mounted within a ground surface;
a subframe member mounted to a base surface of the containment module to extend substantially over the base surface of the containment module;
a tilting frame pivotally mounted to the subframe member and actuable such that a free end of the tilting frame is able to be elevated and lowered with respect to the subframe member;
a extension frame mounted within the tilting frame adjacent the free end thereof, the extension frame actuable to extend from and retract into the extension frame when the extension frame is in an elevated position;
wherein, movement of the tilting frame and the extension frame is controlled by a controller to extend from the ground surface to the vehicle to facilitate ramp access to the vehicle.

2. An access system according to claim 1, wherein the containment module is in the form of a pre-cast concrete member defining an open rectangular structure having an interior space bounded by walls extending in an upright manner from a base surface.

3. An access system according to claim 2, wherein the containment module configured to be embedded into a road.

4. An access system according to claim 3, wherein the base surface is configured to have a one or more drainage channels formed in the surface thereof.

5. An access system according to claim 4, wherein the drainage channels function to direct any water collected within the containment module towards a rear channel formed along a rear wall of the containment module.

6. An access system according to claim 5, wherein water collected in the rear channel is removed via drain pipes into the surrounding soil.

7. An access system according to claim 1, wherein the subframe member is positioned within the containment module to be secured to the base thereof.

8. An access system according to claim 7, wherein the subframe member has an end that extends vertically, the vertically extending end configured to be extend across a rear end of the containment module.

9. An access system according to claim 8, wherein an opposing end of the subframe member is configured to be located along a front end of the containment module.

10. An access system according to claim 9, wherein the opposing end has impact buffers formed along an upper surface thereof.

11. An access system according to claim 10 wherein the impact buffers are in the form of rubber pads.

12. An access system according to claim 7, wherein lifting mechanisms are mounted to opposing sides the subframe member at a central region thereof and are in engagement with the tilting frame.

13. An access system according to claim 12, wherein the lifting mechanisms comprise a cam lifter in communication with at least one motor.

14. An access system according to claim 13, wherein the height of extension of the tilting frame is controlled by controlling rotational orientation of the cam member mounted beneath the tilting frame.

15. An access system according to claim 1, wherein the extension frame is mounted within the tilting frame adjacent a front end thereof.

16. An access system according to claim 15, wherein the extension frame is mounted on runners so as to slide within the extension frame.

17. An access system according to claim 16, wherein a linear actuator is mounted at one end to the tilting frame and is connected to a rear of the extension frame, the linear actuator being actuable to apply a pushing force against the rear of the extension frame to extend the front end of the extension frame beyond the end of the tilting frame and to apply a pulling force against the rear of the extension frame to retract the front end of the extension frame into the end of the tilting frame.

18. An access system according to claim 1, wherein a platform member is mounted to an upper surface of the extension frame.

19. An access member according to claim 18, wherein the platform member moves with the extension frame and has a bumper provided along the free end thereof such that as the platform member extends beyond the tilting frame the bumper contacts the tram.

20. An access member according to claim 19, wherein a decking member is mounted to an upper surface of the tilting frame to extend substantially over the ramp system 15.
